(19) United States
(12) Patent Application Publication
(10) Pub. No.: US 2025/0328145 A1
(43) Pub. Date: Oct. 23, 2025

(54) METHOD FOR CONTROLLING THE RECORDAL OF SENSOR DATA IN A NO RECORDING ZONE

(71) Applicant: Torc Robotics, Inc., Blacksburg, VA (US)

(72) Inventor: Fridtjof Stein, Ostfildern (DE)

(21) Appl. No.: 19/084,197

(22) Filed: Mar. 19, 2025

(30) Foreign Application Priority Data
Apr. 23, 2024 (DE) DE102024111367.7

(51) Int. Cl. G05D 1/247; G05D 1/246; G05D 103/00

(52) U.S. Cl. CPC G05D 1/247; G05D 1/246; G05D 2103/00

(57) ABSTRACT

The present disclosure relates to a method for operating an ego vehicle. Image data of an environment is detected and recorded during a trip using an environment detecting sensor system including multiple different sensors. Static no recording zones for which a recording ban exists are recognized using a digital map stored in the ego vehicle. It is determined whether a no recording zone lies in a detection range of at least one of the sensors. If so, the recording of sensor data of the respective sensor is interrupted and an approved field of view is determined in the map for each affected sensor. The field of view defines which data may be recorded at which location, and a dynamic no recording zone is formed as a moving object which is detected by at least one of the sensors based on external features.

### CROSS-REFERENCE TO RELATED APPLICATIONS

The present application claims priority to German Patent Application No. 102024111367.7 filed on Apr. 23, 2024, and titled “VEHICLE AND METHOD FOR ITS OPERATION”, which is hereby incorporated by reference in its entirety.

### TECHNICAL FIELD

The present disclosure relates to a method for operating a vehicle in an environment with recording restrictions. In particular, the present disclosure relates to a method for recording sensor data in a no-recording zone.

### BACKGROUND

In the future, there will be automatically traveling vehicles on freeways. Such vehicles locate themselves using sensors (typically lidar, camera, and/or radar) and map data in the existing infrastructure and adjust their driving behavior to other road users measured by the sensor system. Sensor data can be recorded in the process. Operators benefit from recording the data in many ways: For example, perception data can provide insights into near-accidents, unsafe driving behavior, or dangerous road conditions and thus improve safety. By analyzing environmental data, companies can optimize routes based on traffic patterns, road conditions, and other variables to improve efficiency. In the event of an accident, recorded data can be crucial in determining the events preceding the incident and in clarifying liability issues. The more data a company collects, the better its underlying algorithms can be trained to improve sensing the environment.

However, in certain prohibited zones, recording sensor data is not permitted for security reasons, meaning that autonomous vehicles may not be able to access these areas. Such restrictions may be subject to different policies in different countries.

WO 2019/014184 A1 describes the processing of remotely detected sensor data. A computer platform having at least a processor, a communications interface, and a memory can receive sensor data collected by the user computer device from a user computer device via the communications interface, using one or more sensors integrated into the user computer device. The computer platform can then analyze the sensor data received from the user computer device by executing one or more data processing modules. Then, the computer platform may generate trip record data based on the analysis of the sensor data received from the user computer device and store the trip record data in a trip record database. In addition, the computer platform can generate user record data based on the analysis of the sensor data received from the user computer device and store the user record data in a user record database.

### BRIEF DESCRIPTION

The present disclosure is based on the object of specifying a system and method for operating a vehicle.

In the following, prohibited zones in which the recording of sensor data is not permitted for security reasons are also referred to as non-recording areas or NORA.

A method for operating an ego vehicle is proposed. The method includes detecting and recording image data of an environment during the trip using an environment detecting sensor system including multiple different sensors, wherein static no recording zones for which a recording ban exists are recognized using a digital NORA map stored in the ego vehicle. The method further includes determining whether a no recording zone is located in a detection range of at least one of the sensors. According to the present disclosure, in this case the method further includes interrupting the recording of sensor data of this sensor and determining an approved field of view in the NORA map for each sensor, wherein the field of view defines which data may be recorded at which location. The method further includes forming a dynamic no recording zone as a moving object that is recognized by at least one of the sensors based on external features.

The present disclosure described here is suitable, for example, for autonomous vehicles, but also for other vehicles that record data, such as partially automated vehicles.

According to the present disclosure, each sensor of the environment detecting sensor system has its own “sensor fence” and pauses the recording when the sensor fence is visible. Therefore, it is not the operating space of the sensor and thus of the vehicle that is restricted, but only the recording. This may even enlarge the vehicle's operating space. The sensor function is therefore retained. The sensor data just do not have any persistence on a data carrier that can be read later. The range of areas that can be navigated by an autonomous vehicle or a vehicle that otherwise records sensor data is thus increased. This makes more efficient routes possible, since time-consuming, expensive, and resource-intensive detours can be avoided. Autonomous vehicles are thus more attractive.

### BRIEF DESCRIPTION OF DRAWINGS

Exemplary embodiments of the present disclosure will be explained in more detail hereinafter with reference to drawings.

FIG. 1 shows a schematic view of a roadway with an ego vehicle driving on it and two no recording zones located next to the roadway.

FIG. 2 shows another schematic view of the roadway with the ego vehicle driving on it in a first position and the no recording zones.

FIG. 3 shows a schematic view of the roadway with the ego vehicle driving on it when reaching a second position.

FIG. 4 shows another schematic view of the roadway with the ego vehicle driving on it when reaching a third position.

FIG. 5 shows a schematic view of a roadway with an ego vehicle driving on it and an oncoming vehicle representing a dynamic no recording zone.

FIG. 6 shows another schematic view of the roadway with the ego vehicle driving on it and the oncoming vehicle representing the dynamic no recording zone.

FIG. 7 shows another schematic view of the roadway with the ego vehicle driving on it and the oncoming vehicle representing the dynamic no recording zone.

FIG. 8 shows a schematic view of an exemplary processing chain of the ego vehicle.

FIG. 9 shows a schematic view of another exemplary processing chain of the ego vehicle.

Corresponding parts are provided with the same reference numerals in all figures.

### DETAILED DESCRIPTION

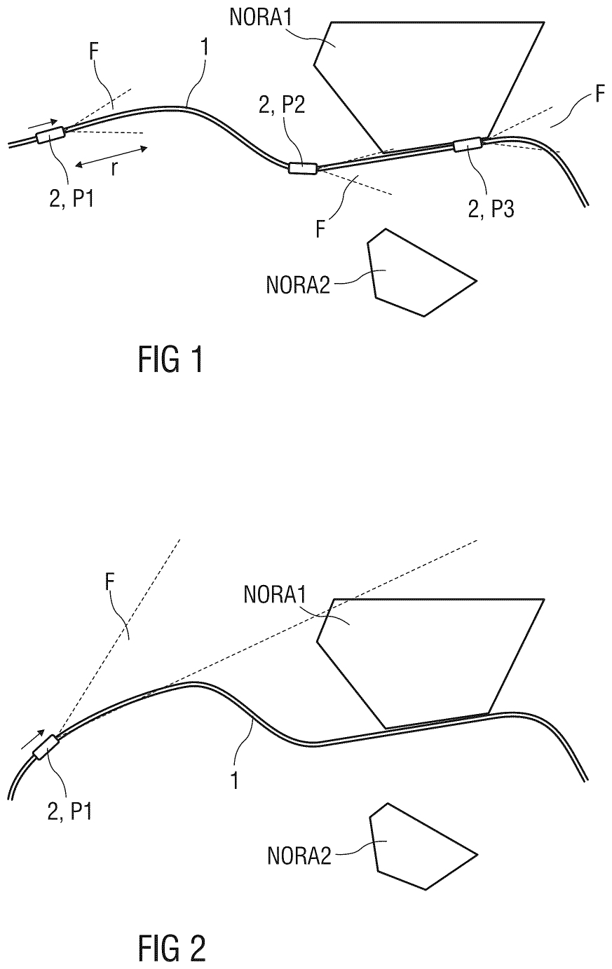

FIG. 1 is a schematic view of a roadway 1 with an ego vehicle 2 driving on it, for example an autonomous or at least partially automated vehicle, as well as two no recording zones NORA1, NORA2 located next to the roadway 1. The ego vehicle 2 is equipped with an environment detecting sensor system 4, including for example at least one camera and/or at least one radar sensor and/or at least one lidar sensor, which system detects at least part of an environment of the ego vehicle 2. The detected environment is symbolized here by a frustum F, which extends up to a detection range r, by which the detection of the environment detecting sensor system 4 or of a specific sensor S1 to Sn of the environment detecting sensor system 4 is limited.

The ego vehicle 2 is further configured to record data detected by the environment detecting sensor system 4. However, the no recording zones NORA1, NORA2 are zones in which such recording is not permitted. If the frustum F of the environment detecting sensor system 4 of the ego vehicle 2 overlaps with such a no recording zone NORA1, NORA2, the ego vehicle 2 may not enter this area unless it is possible to switch off or locally restrict the recording.

In the context of the present disclosure, a distinction is made between static no recording zones NORA1, NORA2 and dynamic no recording zones dNORA. Static no recording zones NORA1, NORA2 are static objects, such as military facilities or other security-sensitive locations such as power plants. Dynamic no recording zones (dNORA) include, for example, a taking off aircraft or a passing vehicle or a passing convoy of vehicles with specially protected, such as high-ranking, occupants, especially politicians.

The ego vehicle 2 is equipped with a digital NORA map 10 which determines an approved field of view for each sensor S1 to Sn of the environment detecting sensor system 4, which field of view defines which data it may record at which location.

For example, a frustum F of a lidar sensor is shown in FIG. 1. At a position P1, the environment detecting sensor system 4 for the lidar sensor is in a recording mode in which the data detected by the lidar sensor is recorded, since the distance of the ego vehicle 2 to a no recording zone NORA1 located in the line of sight of the lidar sensor is greater than its detection range r. The recording of the sensor data of the lidar sensor therefore does not have to be interrupted at position P1 and the environment detecting sensor system 4 can remain in recording mode for the lidar sensor. When a position P2 is reached, the frustum F of the lidar sensor overlaps with the no recording zone NORA1 and this zone is also at least partially within the detection range r. The recording of the sensor data of the lidar sensor is therefore interrupted from position P2 onwards. The environment detecting sensor system 4 is therefore in a non-recording mode for the lidar sensor. However, the detection performance of the lidar sensor remains unaffected. When a position P3 is reached, the frustum F of the lidar sensor no longer overlaps with the no recording zone NORA1. The recording of the sensor data of the lidar sensor therefore continues from position P3. The environment detecting sensor system 4 is therefore once again in a recording mode for the lidar sensor.

FIG. 2 is a schematic view of the roadway 1 with the ego vehicle 2 driving on it and the no recording zones NORA1, NORA2. For example, FIG. 2 shows a frustum F of a camera that has an almost unlimited detection range r. At a position P1, the environment detecting sensor system 4 for the camera is in a recording mode in which the data detected by the camera is recorded. When position P1 is reached, the frustum F of the camera overlaps with the no recording zone NORA1. The recording of the sensor data of the camera is therefore interrupted from position P1 onwards. The environment detecting sensor system 4 is therefore in recording mode for the camera until position P1 is reached and in non-recording mode from position P1 onwards. However, the camera's detection performance remains unaffected.

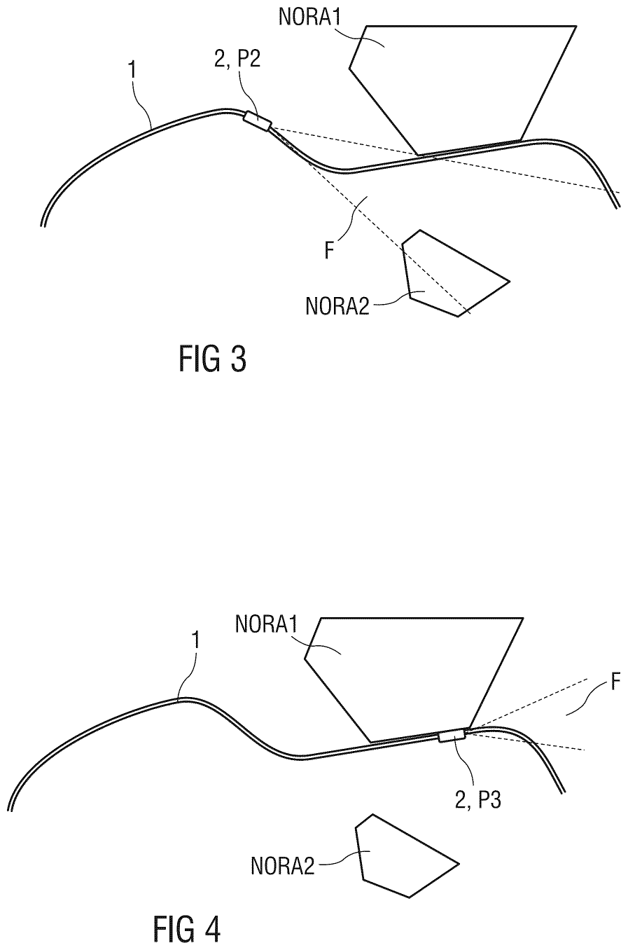

FIG. 3 is a schematic view of the roadway 1 with the ego vehicle 2 driving on it when reaching a position P2 at which the frustum F of the camera no longer overlaps with the no recording zone NORA1, but instead overlaps with the no recording zone NORA2. Therefore, the recording of the sensor data of the camera cannot be continued from position P2 onwards as well. The environment detecting sensor system 4 is therefore still in non-recording mode for the camera.

FIG. 4 is a schematic view of the roadway 1 with the ego vehicle 2 driving on it when reaching a position P3 at which the frustum F of the camera no longer overlaps with the no recording zone NORA1 and also no longer overlaps with the no recording zone NORA2. Therefore, the recording of the sensor data of the camera can be continued from position P3 onwards. The environment detecting sensor system 4 is now in recording mode for the camera.

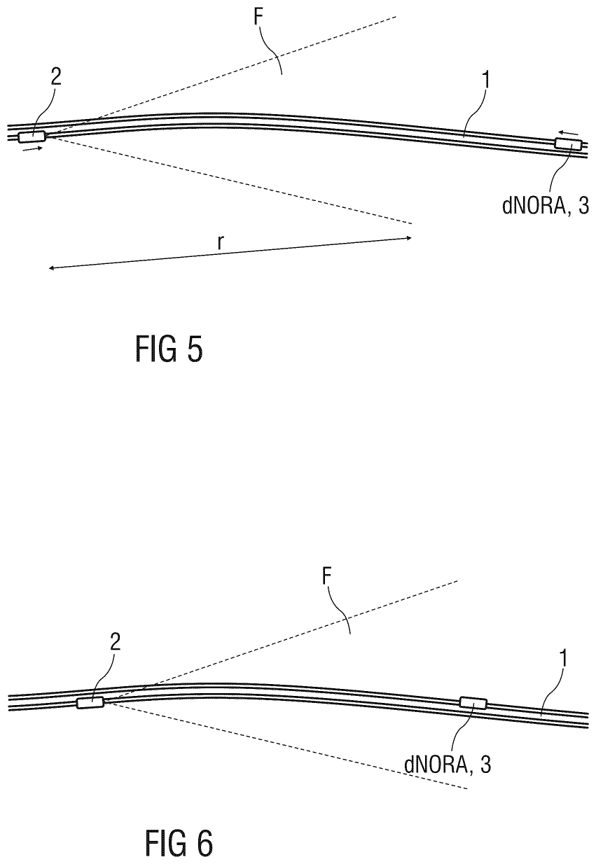

FIG. 5 is a schematic view of a roadway 1 with an ego vehicle 2 driving on it and an oncoming vehicle 3 which represents a dynamic no recording zone dNORA because it transports, for example, particularly protected, occupants, for example high-ranking ones. The vehicle 3 can be identified as a no recording zone dNORA by at least one of the sensors S1 to Sn of the environment detecting sensor system 4, for example the camera, in particular on the basis of external features, for example its license plate or another feature. For example, it may be a well-known vehicle 3 of a president of a country. In the situation shown in FIG. 5, the distance of the ego vehicle 2 to the dynamic no recording zone dNORA, that is, the vehicle 3, is so large that it cannot yet be identified in the sensor data of the camera due to the resolution of the camera. The detection range r of the camera is therefore effectively limited by its resolution. The environment detecting sensor system 4 of the ego vehicle 2 therefore remains in recording mode for the camera.

FIG. 6 is a schematic view of the roadway 1 with the ego vehicle 2 driving on it and the oncoming vehicle 3, which represents a dynamic no recording zone dNORA, wherein the ego vehicle 2 and the vehicle 3 have come so close to each other that the vehicle 3 is within the detection range r of the camera. As soon as the environment detecting sensor system 4 has identified the dynamic no recording zone dNORA from the camera sensor data, the recording of the camera sensor data is interrupted.

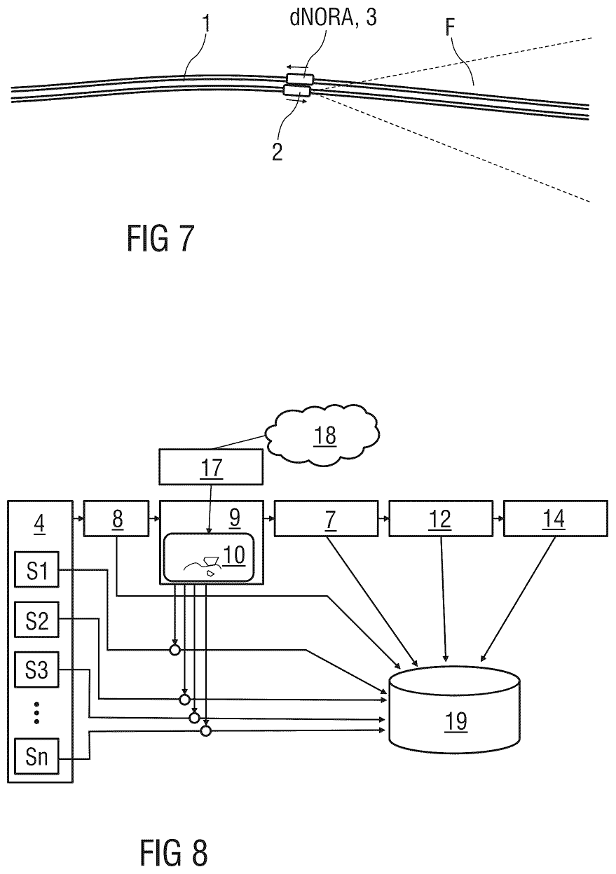

FIG. 7 is a schematic view of the roadway 1 with the ego vehicle 2 driving on it and the oncoming vehicle 3, which represents a dynamic no recording zone dNORA, wherein the ego vehicle 2 and the vehicle 3 pass each other and the vehicle 3 is therefore no longer within the frustum F of the camera. Therefore, recording of the sensor data of the camera can be continued. However, if the ego vehicle 2 has sensors S1 to Sn directed sideways, for example to the left, which continue to detect the vehicle 3 in this situation, the recording of the sensor data of these sensors S1 to Sn is or remains interrupted. The same applies to sensors S1 to Sn which may be directed against the direction of travel.

When dealing with the dynamic no recording zone dNORA, a point in time can also be taken into account. For example, when passing or overtaking a dynamic no recording zone dNORA, recording is suppressed for the corresponding detecting sensors S1 to Sn.

FIG. 8 is a schematic view of an exemplary processing chain of the autonomous ego vehicle 2. By means of the environment detecting sensor system 4, which has a plurality of sensors S1 to Sn, environmental data is recorded, fed to a fusion module 8 for fusion, compared with an internal digital map 9, and localized. In this case, a NORA map 10 is taken into account, in which an approved field of view is determined for each sensor S1 to Sn of the environment detecting sensor system 4, which field of view defines which data of the sensor S1 to Sn may be recorded at which location. The fused data from the fusion module 8 are fed to a situation analysis module 7 and a behavior planning module 12. The behavior planning module 12 is configured to control an actuator system 14 of the ego vehicle 2 for steering, accelerator, and brake.

The digital map 9 can be connected via a wireless communication module 17 to a cloud 18 from which the NORA map 10 can be updated.

The sensor data detected by the sensors S1 to Sn and the data generated by the fusion module 8, the situation analysis module 7, the behavior planning module 12, and the actuator system 14 are further recorded by a data recorder 19.

The following applies to each sensor S1 to Sn, unless expressly stated otherwise:

As soon as its frustum F intersects with a no recording zone NORA1, NORA2, recording of the sensor data of this sensor S1 to Sn is interrupted.

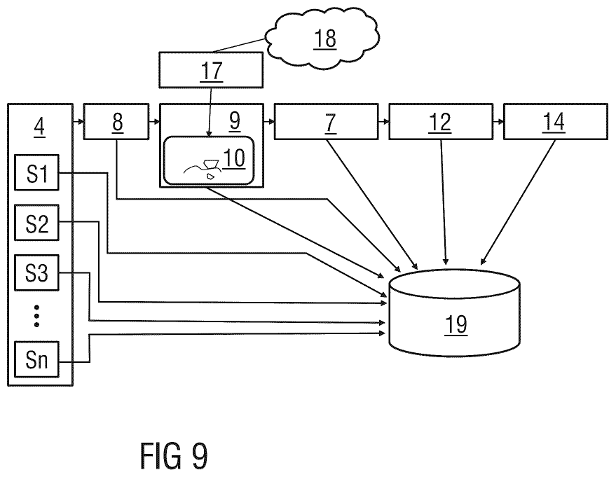

FIG. 9 is a schematic view of an alternative exemplary processing chain of the autonomous ego vehicle 2. By means of the environment detecting sensor system 4, which has a plurality of sensors S1 to Sn, environmental data is recorded, fed to a fusion module 8 for fusion, compared with an internal digital map 9, and localized. In this case, a NORA map 10 is taken into account, in which an approved field of view is determined for each sensor S1 to Sn of the environment detecting sensor system 4, which field of view defines which data of the sensor S1 to Sn may be recorded at which location. The fused data from the fusion module 8 are fed to a situation analysis module 7 and a behavior planning module 12. The behavior planning module 12 is configured to control an actuator system 14 of the ego vehicle 2 for steering, accelerator, and brake.

The digital map 9 can be connected via a wireless communication module 17 to a cloud 18 from which the NORA map 10 can be updated.

The sensor data detected by the sensors S1 to Sn and the data generated by the fusion module 8, the situation analysis module 7, the behavior planning module 12, and the actuator system 14 are further recorded by a data recorder 19.

As soon as the frustum F of one of the sensors S1 to Sn has an intersection with a no recording zone NORA1, NORA2, recording of the sensor data of all sensors S1 to Sn is interrupted.

The ego vehicle 2 can, for example, be designed as a commercial vehicle, a bus, or a passenger car.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A method for operating an ego vehicle (2), the method comprising:
detecting and recording sensor data of an environment during a trip using an environment detecting sensor system comprising a plurality of sensors;
recognizing a number of no recording zones (NORA) for which a recording ban exists using a digital NORA map stored in the ego vehicle;
determining whether at least one of the no recording zones lies within a detection range of at least one of the sensors; and
interrupting, if a no recording zone lies within the detection range of at least one of the sensors, the recording of sensor data of the at least one sensor,
determining an approved field of view in the NORA map for each sensor, wherein the field of view defines which data may be recorded at which location.

2. The method according to claim 1,
wherein when detecting that at least one no recording zone lies in a detection range of at least one of the sensors, the recording of sensor data of all sensors is interrupted.

3. The method according to claim 1,
wherein a detected environment of each sensor is defined by a frustum which extends up to the detection range.

4. The method according to claim 1,
wherein the no recording zones comprise military installations, power plants, and/or other security-sensitive locations.

5. (canceled)

6. An ego vehicle having an environment detecting sensor system comprising multiple different sensors configured to detect sensor data of an environment,
wherein the ego vehicle is configured to:
record senor data of the environment using the environment detecting sensor system,
recognize a number of no recording zones for which a recording ban exists using a digital NORA map stored in the ego vehicle,
interrupt, if at least one no recording zone lies in a detection range of at least one of the sensors, the recording of sensor data of the at least one sensor, and
determine an approved field of view in the NORA map for each sensor, wherein the field of view defines which data may be recorded at which location.

7. The ego vehicle according to claim 6,
wherein the ego vehicle is an autonomous vehicle or a semi-autonomous vehicle.

8. The ego vehicle according to claim 6, wherein the ego vehicle is configured to form a dynamic no recording zone as a moving object which is detected by at least one of the sensors based on external features.

9. The ego vehicle according to claim 6, wherein each respective sensor is selected from a group consisting of a camera; a LiDAR sensor; a radar sensor, and combinations thereof.

10. The method according to claim 1, the method further comprising forming a dynamic no recording zone as a moving object which is detected by at least one of the sensors based on external features.

11. The method according to claim 1, the method further comprising controlling the ego vehicle with the detected sensor data, wherein the detected sensor data is used to control the autonomous vehicle regardless of the presence of at least one no recording zone within a detection range of at least one of the sensors.

12. The method according to claim 1, the method further comprising updating the NORA map by connecting to a cloud.

13. The ego vehicle according to claim 6, the ego vehicle further comprising a behavior planning module, wherein the behavior planning module is configured to control an actuator system of the ego vehicle based on the detected sensor data.

14. The ego vehicle according to claim 6, the ego vehicle further comprising a data recorder configured to store the recorded sensor data.

15. The method according to claim 10,
wherein when detecting that the dynamic no recording zone lies in the detection range of the at least one of the sensors, recording of sensor data of all sensors is interrupted.

16. The method according to claim 10,
wherein a detected environment of each sensor is defined by a frustum which extends up to the detection range.

17. The method according to claim 10,
wherein the dynamic no recording zones comprise aircraft and vehicles as well as vehicle convoys with specially protected occupants.

18. The method according to claim 10, the method further comprising controlling the ego vehicle with the detected sensor data, wherein the sensor data is used to control the autonomous vehicle regardless of the presence of the no recording zone within a detection range of at least one of the sensors.

19. The method according to claim 1, the method further comprising resuming recording of sensor data detected by the at least one sensor once the no recording zone no longer lies in the detection range of the at least one sensor.

20. The method according to claim 2, the method further comprising resuming recording of sensor data detected by all of the sensors once the no recording zone no longer lies in the detection range of the at least one sensor.

21. The method according to claim 10, the method further comprising resuming recording of sensor data detected by the at least one sensor once the dynamic no recording zone no longer lies in the detection range of the at least one sensor.
